(19) United States
(12) Patent Application Publication
(10) Pub. No.: US 2002/0188606 A1
(43) Pub. Date: Dec. 12, 2002

(54) Organizing and accessing electronic business cards by virtual subdomain

(76) Inventors: Chen Sun, Houston, TX (US); Azkar Hussain Choudhry, Houston, TX (US)

Correspondence Address: Chen Sun, P.O. Box 540962, Houston, TX, 77254-0962, US

(21) Appl. No.: 09/853,167

(22) Filed: May 11, 2001

(51) Int. Cl. G06F 7/00

(52) U.S. Cl. 707/10

(57) ABSTRACT

An Internet server and indexing engine which provides an association of electronic business cards to virtual subdomains which allows the server to index, search for, and organize online electronic business cards on a dynamic basis. The collection of electronic business cards may be centralized or co-resident with the indexing web server, or a they may be collection of electronic business cards which are distributed among multiple Internet servers. The virtual subdomains for the online business cards may be repointed dynamically to alternate web object sources as desired without requiring an update of the web indexing server database.

### CROSS-REFERENCE TO RELATED APPLICATIONS

### CLAIMING BENEFIT UNDER 35 U.S.C. 120

This application claims is related to U.S. application Ser. No. 09/476,632 filed by Azkar Choudhry on Dec. 31, 1999 which is commonly assigned with this application.

### FEDERALLY SPONSORED RESEARCH AND DEVELOPMENT STATEMENT

This invention was not developed in conjunction with any Federally-sponsored contract.

### TECHNICAL FIELD OF THE INVENTION

This invention pertains to the arts of computer networks, addressing of computers on computer networks, and the organization and accessing of electronic business cards.

### MICROFICHE APPENDIX

Not applicable. INCORPORATION BY REFERENCE

U.S. application Ser. Nos. 09/476,632 and 09/642,127, both filed by Azkar Choudhry on Dec. 31, 1999 and Aug. 18, 2000, respectively, are incorporated herein by reference in their entirety, including drawings and any microfiche appendices, and are hereby made a part of this application.

### BACKGROUND OF THE INVENTION

The Internet is possibly the greatest advance in information technology since the invention of the Gutenberg movable type printing press. It's impact on society worldwide has truly only been realized to a fraction of its ultimate potential. The Internet is not a single computer network, however, but is a hierarchy of many computer networks, all of which are interconnected by various types of server computers.

Key to success of the Internet is the addressing scheme which was adopted. The addressing scheme allows two types of addressing to be used when one computer transmits data to another computer over the Internet. The first addressing scheme, referred to as the Internet Protocol (“IP”) address, is a numeric address value consisting of four binary octets separated by a period or “dot”, such as AA.BB.CC.DD. Each of the octets is allowed to range in value from 0 to FF hexadecimal, or to 255 decimal. The values towards the left of the address, such as AA and BB, are referred to as network addresses and are used for coarse resolution of the address, while the values towards the right of the address are used for fine resolution of the address, such as CC and DD.

For example, turning to FIG. 1, the Internet backbone (1) is a set of highspeed data transmission facilities which interconnect several key switching and routing centers. Domain servers (2 and 6) may connect directly to the backbone (1), or they may connect indirectly to the backbone through other servers and other networks. For example, the domain server (2) on the right serves the subnetwork (4) on the right, which interconnects one or more client computers (5) to each other and to the Internet. Data or messages to be sent to any of the computers on the right-side network (4) must be properly addressed to be routed to them. For example, the right domain server (2) may be assigned a particular range or set of ranges of IP addresses to serve, such as 155.179.00.XX. A computer on the right-side network (4) may be given an address within this range, such as 155.179.00.213 (in decimal). A second computer on the rightside network (4) may be given an address such as 155.179.00.111. So, the octets towards the right of the IP address are subaddresses of the server's address. This scheme of addressing and subaddressing is well known within the art.

This subaddressing scheme is designed to allow subnetworking as well. For example, as shown in FIG. 1, the left-side domain server (6) may be assigned an IP address range of 98.99.YY.XX (in decimal). Computers directly connected to its subnetwork (8) would receive addresses within this range, as given in the previous example. However, another subnetwork (11), or sub-subnetwork to be literally correct, may be interconnected to the left-side network (8) via another domain server, which may be referred to as a subdomain server (9). This subdomain server may be given a range of IP addresses within the range of IP addresses for the left-side network domain server (6), such as 98.99.192.XX. The inter-networking scheme of the Internet is built upon this hierarchical structure of networks and addresses.

The use of the term “domain” with respect to addressing actually implies more than the numeric IP addressing just discussed, in Internet parlance. While computers may deal well with numeric values for addressing, human users do not deal well with long numbers. When the architects of the early versions of the Internet, known as the ARPAnet, considered previous numbering schemes for humans, such as telephone numbers, they recognized this problem. In order to make the Internet more “userfriendly”, a text-based addressing scheme was “overlaid” on top of the numeric IP addressing scheme. Thus, a hierarchy of text-based addresses was defined. At the top of the hierarchy is a domain, which in general a large range of IP addresses or group of addresses. For example, in FIG. 1, the right-side domain server (2) may be assigned an easy to remember domain name such as “uspto.gov”. Under the Internet domain name convention, the extension of the name following the period or “dot” helps to categorize the type of domain. In this example, “gov” refers to government domains. Coupled with the domain name, “uspto”, a particular domain server is addressed. Other extensions, such as “com” for commercial uses, “edu” for educational institutions and “net” for network services companies, are also available.

In order for messages and data to be actually routed to a computer using a domain name, a translation to a numeric IP address must be made. This is done by a number of distributed “domain name servers” (“DNS”), which can be queried by Internet routers to provide the translation. Each domain server maintains records regarding IP-to-domain name assignments for the domains which it serves. This translation technique and the protocol for updating records is described in the Internet Request For Comment (“RFC”) papers, which are public documents available from InterNIC. Of particular interest are:

a. RFC1033, Domain Administrators Operations Guide

b. RFC 1034, Domain Names—Concepts and Facilities, and

c. RFC 1035, Domain Name—Implementation and Specification.

These are public documents, and are well known within the art.

Continuing with the analogical structure to numeric IP addressing, domain names may be broken into two types of more resolute addresses. The first type is based upon directory structure of the file system on the server. For example, a subdirectory on the US Patent and Trademark Office's web server which contains general information might be named “gen_info”, and could be addressed as “www.uspto.gov/gen info”.

Subnetworks and virtual subnetworks may be addressed by prefixing the general domain name with a subdomain name or names. For example, a subnetwork which serves only the trademark division of the US Patent and Trademark Office may be given the subdomain name “tm”, allowing the subdomain server (such as 9 in FIG. 1) to be addressed as “tm.uspto.gov”. The two addressing schemes can be combined, such as “tm.uspto.gov/gen_info”, which would access a file named “gen_info.html” located in the root directory of the subdomain server for “tm” under the domain server for “uspto.gov”. Alternatively, if a subdirectory called “gen_info” exists on the subdomain server “tm”, a file named “index.html” (or any other default file) may be accessed by a web browser which is pointed to this full address.

Virtual subdomains are special cases of subdomains, which may or may not actually refer to a separate physical subdomain server from the domain server, but may refer to a directory or other software facility on the domain server. This is referred to as “hosting” the subdomain on the domain server. Later, if the owner of the subdomain desires, a separate subnetwork may be established with a separate subdomain server.

Just as paper business cards have been a fundamental tool for exchanging personal contact information between business persons, electronic business cards have become very common to exchange over the internet or via email. Most electronic business card services are free, or nearly free, such as Netscape's Net Business Center and Net Business Card. Most of these services are co-marketed with other types of advertising and allow for searching of a database to view a business card.

As shown in FIG. 4, the current technology uses a CGI form which is sent (40) to a user of a web browser. The user then completes and submits (41) the form back to a web server, which then parses (42) the response data and formulates a database query.

This data base query (43) is then sent to the database (44) which contains registered user business card information. The queried information is returned by the database (44) to the web server which then creates a dynamic web object (45). In this example, the dynamic web object is an electronic business card which is transmitted to the web browser user who then views it (46).

The main problem with this method is that the database query is created dynamically in response to specific information provided by the user in the CGI form.

For example, a CGI query on Netscape's Net Business Card for a business card for a patent attorney would appear as shown below.

TABLE 1
Example Query to a Database of Electronic Business Cards

http://yp.superpages.com/listings.phtml?SRC=aol&STYPE=S&PG=
L&search=Find+It&N=&C=lawyer&T=chicago&S=

Referring to this example query which was posted to AOL's online yellow pages in order to find an electronic business card for a lawyer in Chicago, a CGI query is added to the end of the hyperlink or web address of the web server in this case, “superpages.com”. One can see that within the query is buried the string which was supplied in the CGI form by the user, “lawyer” and “Chicago”.

Even though this kind of online business card in advertising is useful for some purposes, it is not conveniently accessed through any other means other than the accessing of the CGI form and completing of the CGI form. For example, this string would not be practical to be inserted into an electronic mail message to allow a recipient of an email message to easily access the business card online. Further, as the operator of the online business card data base server may change the database interface, a holder of an online business card in the database may not depend on the query string being unchanging over time. Therefore, there is a need in the art for a more convenient way to access and organize electronic business card via a computer internet such as the Internet, and to effectively transmit or specify a link to electronic business cards.

### SUMMARY OF THE INVENTION

The present invention associates a virtual subdomain name with an electronic business card or other home page type information web object, referred to as the “webBIZdex”. The webBIZdex is a searchable index of online electronic business cards such as webBIZcards. WebBIZcards are formed by associating with an online business card a virtual subdomain name, such as John.collegealum.edu, instead of a longer CGI database query or a subdirectory name such as collegealum.edu/John. By using a virtual subdomain as the link to access a webBIZcard or other electronic business card online, a user may quickly find and contact desired members or holders of electronic business cards. And, a holder of a webBIZcard may easily insert the virtual subdomain as a hyperlink in any HTML or other web object such as an email message. As the virtual subdomain which is described in the related and incorporated application is a dynamically created and dynamically managed addressing scheme, the webBIZdex itself may actually be a distributed database across multiple servers and may be dynamically reorganized and changed. This further allows the owners or holders of the electronic business cards to easily and quickly update there own personal information within any database which is linked to the virtual or which is associated to the virtual subdomain for his business card.

### BRIEF DESCRIPTION OF THE DRAWINGS

The figures presented herein when taken in conjunction with the disclosure form a complete description of the invention, wherein elements and steps indicated by like reference indicators are the same or equivalent elements or steps.

FIG. 1 presents the prior art arrangement of domain servers and subdomain servers in a computer network such as the Internet.

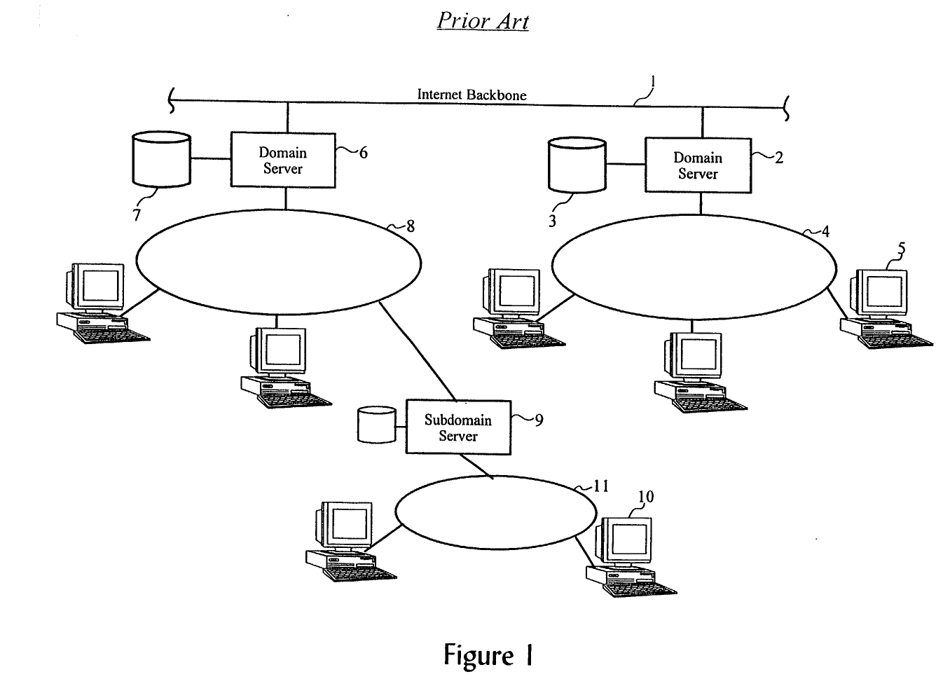

FIG. 2 shows the general architecture of an Apache HTTP server.

FIG. 3 depicts the basic communication process and arrangement between an Internet browser computer, an ISP, and domain name server, and a domain server.

FIG. 4 illustrates the method currently in use to organize, search for, and present electronic business cards using database queries.

FIG. 5 presents in logical flow of the invention to organize, search for, and present electronic business cards using virtual subdomains.

### DETAILED DESCRIPTION OF THE INVENTION

The invention is preferably realized using an Apache HTTP (Hyper Text Transfer Protocol) Web Server as the basic platform. The Apache server is well known within the art, and is possibly the most popular web server used today. Many webmasters are capable of configuration and installation of such a server, and they can be readily obtained from companies such as Apache Digital Corporation of Durango, Colorado.

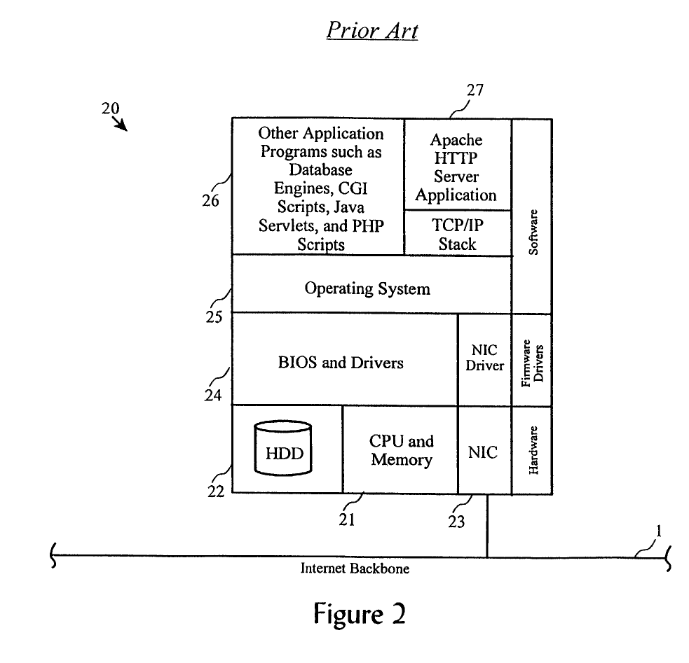

FIG. 2 shows the well known architecture of an Apache HTTP server. The server is a combination of a computer platform with specialized software. The computer platform generally consists of a central processing unit (“CPU”) with memory (21), one or more hard disk drives (“HDD”) (22), and a network interface card (“NIC”) (23). This may be an IBM-compatible personal computer, as in the preferred embodiment, or Sun workstation or other suitable standard computer platform. A Basic Input/Output System (“BIOS”) and set of low level driver firmware modules (24) typically interfaces the higher-level software to the hardware, including a NIC driver. An multi-tasking operating system (“OS”) (25), such as Microsoft Windows NT, Linux, Unix or IBM OS/2, is also installed on the computer platform. Linux is the operating system of the preferred embodiment.

The Apache HTTP server software (27) is available for free download from the Apache Software Foundation at http://www.apache.org. It is an application program which interfaces to the Internet (1) through the NIC (23) and a Transmission Control Protocol/Internet Protocol (“TCP/IP”) communications protocol stack. The TCP/IP stack may be native to the OS, or it may be supplied as a separate but compatible module with the Apache application and the OS. Other application programs (26) such as database engines, CGI scripts, Java servlets and PHP scripts may be executed on the same platform simultaneously to the Apache HTTP server application. PHP/FI is a scripting language that supports dynamic HTML pages. It is similar to Apache's SSI, but more complex and has database modules for the most popular databases. PHP/FI is a product of Iquest Internet of Indianapolis, Ind. In the preferred embodiment, the NIC is a 100BaseT local area network interface card, interconnected to the Internet (1) via one or more routers.

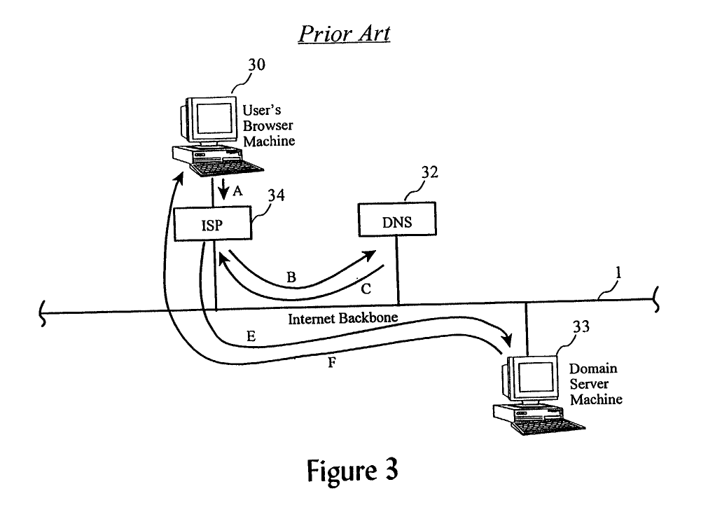

FIG. 3 shows the well known arrangement of Internet browser computers, Domain Name Servers (“DNS”), Internet Service Providers (“ISP”), and domain servers. The internal architecture of domain name servers is fully described in RFC 1035. In general, when a user selects a network address, such as “http://www.anycompany.com”, in his web browser software, the browser machine (30) transmits a request (A) to the ISP (34). The ISP (34) then contacts (B) the DNS (32), which returns a translation (C) of the text-based URL to a numerical IP address value. The user's browser then requests (E) a document from the domain server (33) located at the IP address given by the DNS. The domain server (33) transmits (F) the document, typically in HTML, to the browser machine (30) via the ISP.

The invention is realized by associating a web server script with a virtual subdomain server. Of course, the script may be co-resident within the same web server or house or hosted within different web servers. The virtual subdomain server is described in the related application. The virtual subdomain server translates virtual subdomains to other types of Internet addressing schemes such as subdirectory names or other domains and subdomains. As this is done in real time, the virtual subdomain may be repointed to any other destination address as desired dynamically.

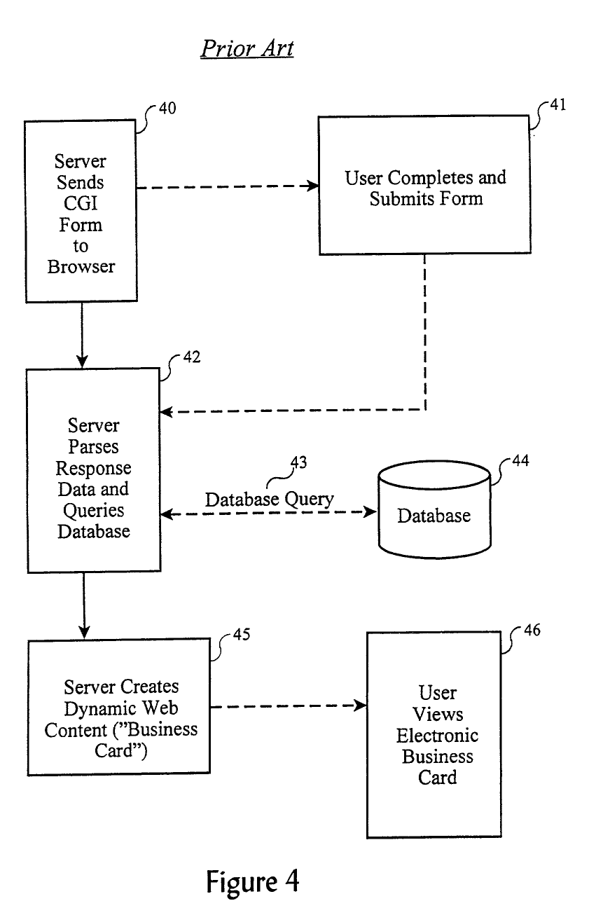

Turning to FIG. 4, the webBIZdex web server script for providing a searchable index of online business cards transmits (50) to the web browser user a form to collect information on which to find business cards. This form may be sent to the web browser user using a CGI type form or other type form such as a Java form. The user completes the form and submits (51) it to the webBIZdex server.

The form data is received by the web server script and parsed (52) to create a database search query. However, unlike systems of the current technology, this database query string is never visible to or provided to the user. The search query (54) is answered by the database by returning one or more records containing the data requested by the search query including one or more virtual subdomain addresses.

The server script creates (55) a list of available business cards comprised of multiple virtual subdomain entries, such as “john.collegealum.edu”, and transmits this list to the web browser user. The web browser user may then simply hyperlink (57) or select any of the virtual subdomains, which will activate the process described in the related application whereby the virtual subdomain server intercepts the request for the unregisterd virtual subdomain name and translates it to an actual web address. At this actual web address may be any web object, such as an electronic business card.

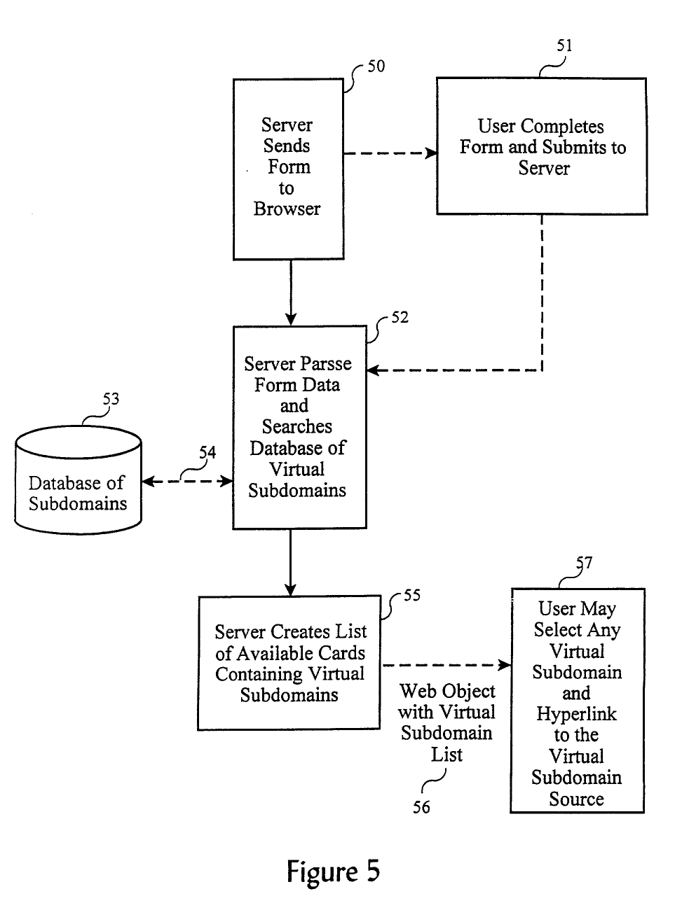

As such, the method of the webBIZdex web server script as shown in FIG. 5 has several advantages over the current technology. First, the script or server maintains a centralized database of web business card web objects, including a database of virtual subdomains associated with online business cards. The online business cards themselves (or other web objects) may be distributed among one or many other web servers, and are associated and accessed via the virtual subdomain address. Thus, the “index engine” such as the web server script just described only must return in response to a query a list of available virtual subdomains and does not need to create graphic images.

Secondly, the owner of a web business card may redirect his virtual subdomain to any web source, at any time, dynamically, due to the dynamic nature of the virtual subdomain redirection capabilities. This eliminates the costly expense of maintenance of a large centralized database of electronic business cards.

Thirdly, this method does not stay involved (e.g. “in the loop”)with the processing and transmission of the actual online business card web objects after the search is completed, thereby allowing it to process more requests per unit of time than the current technology system which also transmits the electronic business cards.

Fourth, this system and method allows a user of a webBIZcard to include a simple hyperlink, a virtual subdomain, in other web objects such as e-mail messages, to allow other web browser user's to quickly and efficiently access his or her online business card.

While the disclosure contained herein has set forth a preferred embodiment of the invention, and many of the fundamental components used within the invention are well known within the art, it will be appreciated by those who are skilled in the art that variations to the combination of elements and steps disclosed can be made without departing from the scope and spirit of the invention. Such variations may include, but are not limited to, selection of alternate web server hardware platforms, operating systems, and HTTP server suites, as well as implementation of the process as a servlet or other program embodiment.

What is claimed is:

1. A method for organizing and accessing online business card using virtual subdomain addresses over a computer network, comprising the steps of:
receiving from an Internetworked client computer a request with criteria for a group of online business cards;
determining which virtual subdomain addresses associated with online business cards meet said request criteria; and
sending a web object containing at least one virtual subdomain address associated with said online business cards which meet said request criteria to said Internetworked client computer via a computer network.

2. The method as set forth in claim 1 wherein said step of receiving a request with criteria for a group of online business cards comprises receiving a completed Common Gateway Interface (“CGI”) form containing criteria from an Internetworked client computer.

3. The method as set forth in claim 1 wherein said step of determining which virtual subdomain addresses associated with online business cards meet said request criteria comprises querying a database for all records which meet said criteria.

4. The method as set forth in claim 1 wherein said step of sending a web object containing at least one virtual subdomain address to said Internetworked client computer comprises sending a Hyper Text Markup Language (“HTML”) page containing one or more hyperlinked virtual subdomain addresses.

5. A computer-readable medium containing program code for organizing and accessing online business card using virtual subdomain addresses over a computer network, said program code when executed by an Internetworked server computer causing the Internetworked server computer to perform the steps of:
receiving from an Internetworked client computer a request with criteria for a group of online business cards;
determining which virtual subdomain addresses associated with online business cards meet said request criteria; and
sending a web object containing at least one virtual subdomain address associated with said online business cards which meet said request criteria to said Internetworked client computer via a computer network.

6. The computer-readable medium as set forth in claim 5 wherein said program code for receiving a request with criteria for a group of online business cards comprises program code for receiving a completed Common Gateway Interface (“CGI”) form containing criteria from an Internetworked client computer.

7. The computer-readable medium as set forth in claim 5 wherein said program code for determining which virtual subdomain addresses associated with online business cards meet said request criteria comprises program code for querying a database for all records which meet said criteria.

8. The computer-readable medium as set forth in claim 5 wherein said program code for sending a web object containing at least one virtual subdomain address to said Internetworked client computer comprises program code for sending a Hyper Text Markup Language (“HTML”) page containing one or more hyperlinked virtual subdomain addresses.

9. An Internet online business card index server system for organizing and accessing online business cards using virtual subdomain addressing comprising:
a request receiver for receiving a request with criteria from an Internetworked client computer via a computer network;
a request handler for parsing said request and criteria and for querying a database for matching records;
a response web object builder for creating a response web object containing one or more virtual subdomains indicated by said matching records; and
a response transmitter for transmitting the response web object to said Internetworked client computer via a computer network such that a recipient may view and select a hyperlinked virtual subdomain address to access an online business card meeting said criteria.

10. The system as set forth in claim 9 further comprising a Hyper Text Transfer Protocol (“HTTP”) web server.

11. The system as set forth in claim 9 wherein said request receiver is adapted to received posted data and forms from an Internet browser computer.

12. The system as set forth in claim 9 wherein said request handler is adapted to parse completed and posted Common Gateway Interface (“CGI”) forms from an Internet browser computer.

13. The system as set forth in claim 9 wherein said response web object builder is adapted to build Hyper Text Markup Language (“HTML”) pages containing hyperlinked virtual subdomain addresses.

14. The system as set forth in claim 9 wherein said response transmitter is adapted to transmit Hyper Text Markup Language (“HTML”) pages containing hyperlinked virtual subdomain addresses to an Internetworked client computer.
